(19) United States
(12) Patent Application Publication
(10) Pub. No.: US 2026/0219033 A1
(43) Pub. Date: Jul. 30, 2026

(54) MEASURING APPARATUS, MEASURING METHOD, AND STORAGE MEDIUM

(71) Applicant: Kioxia Corporation, Tokyo (JP)

(72) Inventors: Kazuyuki MASUKAWA, Yokohama Kanagawa (JP); Takaki HASHIMOTO, Yokohama Kanagawa (JP); Takuji OHASHI, Yokohama Kanagawa (JP); Ai FURUBAYASHI, Yokohama Kanagawa (JP)

(73) Assignee: Kioxia Corporation, Tokyo (JP)

(21) Appl. No.: 19/319,758

(22) Filed: Sep. 5, 2025

(30) Foreign Application Priority Data
Jan. 30, 2025 (JP) 2025-014151

(51) Int. Cl. G01B 11/06; G01K 11/12

(52) U.S. Cl. CPC G01B 11/06; G01K 11/12

(57) ABSTRACT

According to one embodiment, a measuring apparatus includes a light source, a spectrometer, a storage device, and a processor. The processor is configured to: perform Fourier transform of a spectroscopic spectrum waveform measured by the spectrometer; calculate a thickness or a temperature of a target as a first measurement value; calculate a phase angle before unwrapping as a second measurement value; extract first true value candidates corresponding to the first measurement value from a first correction table; extract second true value candidates corresponding to the second measurement value from a second correction table; and output, as a thickness or a temperature of the target, a value based on a first true value candidate and a second true value candidate that are same or closest among the extracted first and second true value candidates.

### CROSS-REFERENCE TO RELATED APPLICATIONS

This application is based upon and claims the benefit of priority from Japanese Patent Application No. 2025-014151, filed Jan. 30, 2025, the entire contents of which are incorporated herein by reference.

### FIELD

Embodiments described herein relate generally to a measuring apparatus, a measuring method, and a storage medium.

### BACKGROUND

A method of measuring a wafer thickness or a wafer temperature using optical interference is known.

### BRIEF DESCRIPTION OF DRAWINGS

FIG. 1 is a block diagram illustrating an example of configurations of a measuring apparatus and a processing apparatus according to a first embodiment.

FIG. 2 is a block diagram illustrating an example of a configuration of a computer included in the measuring apparatus according to the first embodiment.

FIG. 3 is a schematic diagram illustrating an example of a configuration of a chamber included in the processing apparatus according to the first embodiment.

FIG. 4 is a time chart illustrating an example of behavior of a wafer temperature and an ESC temperature during a process by the processing apparatus according to the first embodiment.

FIG. 5 is a diagram illustrating an example of a component of interference light in a case where a wafer as a measurement target is a single layer.

FIG. 6 is a diagram illustrating an outline of wafer temperature measurement using optical interference in the first example.

FIG. 7 is a diagram illustrating an example of a component of interference light in a case where the wafer as a measurement target has a proximity layer.

FIG. 8 is a diagram illustrating an outline of wafer temperature measurement using optical interference in a second example.

FIG. 9 is a diagram illustrating an outline of wafer temperature measurement using optical interference in the third example.

FIG. 10 is a diagram illustrating an example of a method of sampling a measurement result by a spectrometer included in the measuring apparatus according to the first embodiment.

FIG. 11 is a diagram illustrating an example of a measurement error in the spectrometer included in the measuring apparatus according to the first embodiment.

FIG. 12 is a flowchart illustrating an example of preliminary preparation for measurement processing by the measuring apparatus according to the first embodiment.

FIG. 13 is a diagram illustrating an example of a first correction table generated by the measuring apparatus according to the first embodiment.

FIG. 14 is a diagram illustrating an example of a second correction table generated by the measuring apparatus according to the first embodiment.

FIG. 15 is a flowchart illustrating an example of measurement processing by the measuring apparatus according to the first embodiment.

FIG. 16 is a diagram illustrating an example of a spectroscopic spectrum measured by the measuring apparatus according to the first embodiment.

FIG. 17 is a diagram illustrating an example of a complex amplitude obtained by Fourier transform of the measuring apparatus according to the first embodiment.

FIG. 18 is a diagram illustrating an example of the complex amplitude near a wafer thickness extracted by the measuring apparatus according to the first embodiment.

FIG. 19 is a diagram illustrating an example of complex amplitudes before and after removal of a spiral component by the measuring apparatus according to the first embodiment.

FIG. 20 is a diagram illustrating an example of a planar Gaussian waveform and a phase angle corresponding to an amplitude peak position by the measuring apparatus according to the first embodiment.

FIG. 21 is a diagram illustrating a method of selecting a thickness true value by the measuring apparatus according to the first embodiment.

FIG. 22 is a diagram describing advantages of the measuring method by the measuring apparatus according to the first embodiment.

FIG. 23 is a diagram illustrating an example of an experimental result used in extrapolation processing by a measuring apparatus according to a second embodiment.

FIG. 24 is a diagram illustrating a relationship between a phase angle and a thickness error obtained by extrapolation processing by the measuring apparatus according to the second embodiment.

FIG. 25 is a diagram illustrating an example of a first correction table and a second correction table generated by the measuring apparatus according to the second embodiment.

FIG. 26 is a diagram describing advantages of a measuring method by the measuring apparatus according to the second embodiment.

FIG. 27 is a flowchart illustrating an example of preliminary preparation for measurement processing by a measuring apparatus according to a third embodiment.

FIG. 28 is a flowchart illustrating an example of measurement processing by the measuring apparatus according to the third embodiment.

### DETAILED DESCRIPTION

In general, according to one embodiment, a measuring apparatus includes a light source, a spectrometer, a storage device, and a processor. The light source is configured to emit measurement light having a wavelength that transmits through a measurement target object. The spectrometer is configured to measure a spectroscopic spectrum waveform of light in which the measurement light is reflected from a measurement target object. The storage device is configured to store a first correction table and a second correction table. The first correction table includes a measurement value of a thickness or a temperature and a true value of the thickness or the temperature. The second correction table includes a measurement value of a phase angle and a true value of the thickness or the temperature. The processor is configured to: perform Fourier transform of the spectroscopic spectrum waveform measured by the spectrometer; calculate a thickness or a temperature of the measurement target object as a first measurement value based on an amplitude peak position of the waveform after the Fourier transform; calculate a phase angle before unwrapping as a second measurement value based on an amplitude peak position of the waveform after the Fourier transform; extract a plurality of first true value candidates corresponding to the first measurement value from the first correction table; extract a plurality of second true value candidates corresponding to the second measurement value from the second correction table; and output, as a thickness or a temperature of the measurement target object, a value based on a first true value candidate and a second true value candidate that are same or closest among the extracted first true value candidates and the extracted second true value candidates.

Each embodiment will be described below with reference to the drawings. Each embodiment exemplifies an apparatus and a method for embodying the technical idea of the invention. The drawings are schematic or conceptual. Dimensions, ratios, and the like of each drawing are not necessarily the same as actual ones. The illustration of the configuration is omitted as appropriate. In the present specification, components having substantially the same function and configuration are denoted by the same reference numerals. Numbers, characters, and the like added to reference numerals are referred to by the same reference numerals, and are used to distinguish between similar elements.

### <1> First Embodiment

The measuring apparatus 100 according to the first embodiment derives a wafer thickness using a peak position and a phase angle of a complex amplitude obtained by Fourier transform of an interference spectrum acquired using optical interference. Hereinafter, the measuring apparatus 100 according to the first embodiment will be described in detail.

### <1-1> Configurations

### <1-1-1> Configurations of Measuring Apparatus 100 and Processing Apparatus 200

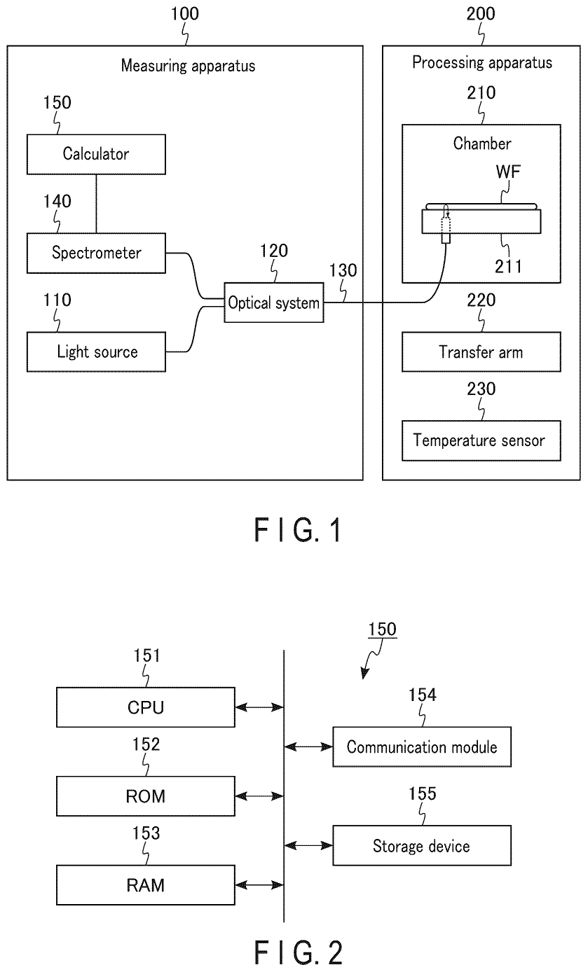

FIG. 1 is a block diagram illustrating an example of configurations of a measuring apparatus 100 and a processing apparatus 200 according to the first embodiment. Hereinafter, an example of a configuration of each of the measuring apparatus 100 and the processing apparatus 200 according to the first embodiment will be sequentially described with reference to FIG. 1.

### (Configuration of Measuring Apparatus 100)

The measuring apparatus 100 is configured to measure at least one of a wafer temperature and a wafer thickness using optical interference. A measurement target object of the measuring apparatus 100 is, for example, a semiconductor substrate such as a silicon wafer or a sapphire wafer. A silicon oxide film, a silicon nitride film, a pattern, and the like may be provided on the wafer as a measurement target. The measuring apparatus 100 can measure the wafer temperature or the wafer thickness during a process (during processing) by the processing apparatus 200. The measuring apparatus 100 includes, for example, a light source 110, an optical system 120, a measurement probe 130, a spectrometer 140, and a calculator 150.

The light source 110 is configured to be capable of emitting measurement light. The wavelength of light generated by the light source 110 includes a wavelength that passes through a film of at least one layer included in the measurement target object, and is, for example, equal to or more than 1 μm. As the light source 110, for example, an amplified spontaneous emission (ASE) light source or a super luminescent diode (SLD) light source is used.

The optical system 120 guides light (measurement light) incident from the light source 110 to the measurement probe 130. In addition, the optical system 120 guides light (interference light) incident from the measurement probe 130 to the spectrometer 140. The optical system 120 includes, for example, an optical coupler.

The measurement probe 130 is configured to irradiate a measurement target of wafer temperature or wafer thickness with measurement light from the optical system 120 and capture interference light reflected from the measurement target. The interference light captured by the measurement probe 130 is guided to the optical system 120.

The spectrometer 140 measures an electromagnetic wave spectrum of the interference light incident from the optical system 120. Then, the spectrometer 140 outputs data of the measured electromagnetic wave spectrum to the calculator 150. The electromagnetic wave spectrum measured by the spectrometer 140 may be referred to as a “spectroscopic spectrum” or may be referred to as an “interference spectrum”.

The calculator 150 calculates at least one of the temperature or the thickness of the measurement target based on data of the interference spectrum received from the spectrometer 140. Details of a method of measuring the temperature and the thickness using the interference spectrum by the calculator 150 will be described later.

### (Configuration of Processing Apparatus 200)

The processing apparatus 200 is an apparatus that executes a predetermined semiconductor manufacturing process on a wafer. The predetermined semiconductor manufacturing process is, for example, an etching process, a film forming process, or the like. The processing apparatus 200 includes, for example, a chamber 210, a transfer arm 220, and a temperature sensor 230.

The chamber 210 is, for example, a sealed reaction vessel for causing physical and chemical reactions to a wafer WF. A wafer stage 211 is disposed in the chamber 210. A wafer WF to be processed can be arranged on the wafer stage 211. The measurement probe 130 of the measuring apparatus 100 is connected to the wafer stage 211 so as to be able to irradiate the wafer WF as a measurement target of at least one of the wafer temperature and the wafer thickness with light. The wafer WF as a measurement target of at least one of the wafer temperature and the wafer thickness includes, for example, the wafer WF to be processed.

The transfer arm 220 has a function of transferring the wafer WF in the processing apparatus 200. The wafer WF can be taken in and out of the chamber 210 by the transfer arm 220. Although not illustrated, the temperature sensor 230 is connected to the wafer stage 211. The temperature sensor 230 directly measures the temperature of the wafer stage 211.

Note that the processing apparatus 200 may include a temperature sensor in addition to the temperature sensor 230 connected to the wafer stage 211. For example, the processing apparatus 200 may include a temperature sensor for measuring the temperature of the wafer WF held by the transfer arm 220. In addition, the processing apparatus 200 may include a dedicated thermostatic chamber on which a temperature sensor is mounted in order to measure the temperature of the wafer WF. The type of temperature sensor to be mounted may be different depending on a place to be used.

### <1-1-2> Configuration of Calculator 150

FIG. 2 is a block diagram illustrating an example of a configuration of a calculator 150 included in the measuring apparatus 100 according to the first embodiment. As illustrated in FIG. 2, the calculator 150 includes, for example, a central processing unit (CPU) 151, a read only memory (ROM) 152, a random access memory (RAN) 153, a communication module 154, and a storage device 155.

The CPU 151 is a processor capable of executing various programs including a measurement program, and controls the entire operation of the calculator 150. The ROM 152 is, for example, a nonvolatile semiconductor memory, and stores a program for controlling the calculator 150, the measurement program, control data, and the like. The RAM 153 is, for example, a volatile semiconductor memory, and is used as a work area of the CPU 151. The communication module 154 is a communication circuit configured to be able to receive the data of the interference spectrum acquired by the spectrometer 140. The communication module 154 further configured to be able to communicate with the processing apparatus 200, and be able to transmit the information obtained by the measuring apparatus 100. The storage device 155 is a nonvolatile storage device. The storage device 155 stores, for example, information used in the measurement process.

Note that the storage device 155 may be externally connected to the calculator 150. The calculator 150 may be prepared independently of the measuring apparatus 100. That is, the calculator 150 may be externally connected. The function as the calculator 150 can be implemented by a program. Instead of the CPU 151, a micro processing unit (MPU), an application specific integrated circuit (ASIC), a field-programmable gate array (FPGA), or the like may be used. Each of the processing described in each embodiment may be implemented by dedicated hardware, or processing executed by software and processing executed by hardware may be mixed.

### <1-1-3> Configuration of Chamber 210

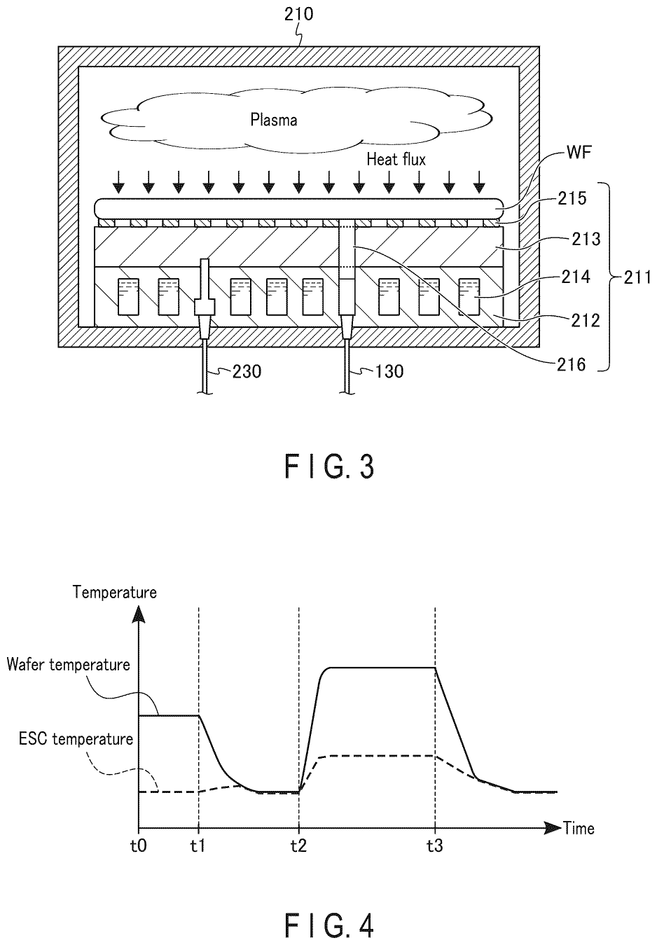

FIG. 3 is a schematic diagram illustrating an example of a configuration of a chamber 210 included in the processing apparatus 200 according to the first embodiment. FIG. 3 illustrates a state in which the processing apparatus 200 is an etching apparatus and is in process (for example, during etching) on the wafer WF. As illustrated in FIG. 3, the wafer stage 211 disposed in the chamber 210 includes, for example, a support base 212 and an electric static chuck (ESC) 213.

The support base 212 supports the electric static chuck 213. The support base 212 has a refrigerant flow path, and is configured to be capable of adjusting the temperature by a refrigerant 214 included in the refrigerant flow path. The temperature of the refrigerant 214 can be controlled by a chiller. A temperature sensor 230 is installed under the support base 212. For example, the temperature sensor 230 is disposed to directly measure the temperature of the electric static chuck 213.

The electric static chuck 213 is configured to be capable of chucking (fixing) the wafer WF. A plurality of pins 215 is disposed on the electric static chuck 213. When the electric static chuck 213 chucks the wafer WF, the plurality of pins 215 support the bottom surface of the wafer WF. Further, the electric static chuck 213 has an observation window 216. The observation window 216 is configured to transmit infrared light, for example. The measurement probe 130 of the measuring apparatus 100 is arranged in the observation window 216. The measurement probe 130 can irradiate a back surface of the wafer WF with measurement light via the observation window 216 and capture interference light reflected from the wafer WF.

The transfer arm 220 can convey the wafer WF to be measured for at least one of the wafer temperature and the wafer thickness onto the electric static chuck 213. The electric static chuck 213 can chuck the wafer WF by receiving charge supply from plasma generated in the chamber 210 and charging the wafer WF. During etching, the wafer WF is heated by receiving heat flux from the plasma. The heat generated in the wafer WF may move to the electric static chuck 213. The wafer stage 211 may be configured to be able to supply helium gas for cooling the wafer WF between the wafer WF and the electric static chuck 213 when the electric static chuck 213 chucks the wafer WF. In this case, the wafer WF can be cooled by helium gas filled between the wafer WF and the electric static chuck 213. The temperature of the refrigerant 214 can be controlled based on the temperature of the electric static chuck 213 measured by the temperature sensor 230 in such a manner that the temperature of the electric static chuck 213 is constant.

### (Relationship Between Wafer Temperature and ESC Temperature)

FIG. 4 is a time chart illustrating an example of behavior of the wafer temperature and the ESC temperature during the process by the processing apparatus 200 according to the first embodiment. The wafer temperature corresponds to the temperature of the wafer WF during the process by the processing apparatus 200. The ESC temperature corresponds to the temperature of the electric static chuck 213 measured by the temperature sensor 230. Hereinafter, an example of behavior of the wafer temperature and the ESC temperature during the process will be described with reference to FIG. 4.

Time t0 corresponds to the time when the wafer WF is transferred into the chamber 210. At time t0, the wafer WF and the electric static chuck 213 are not in contact with each other. Thus, at time t0, each of the wafer temperature and the ESC temperature maintains an initial temperature. For example, the wafer initial temperature is higher than the ESC initial temperature.

Thereafter, at time t1, the wafer WF is chucked by the electric static chuck 213, and a helium gas for cooling flows between the wafer WF and the electric static chuck 213. Then, each of the wafer temperature and the ESC temperature approaches and eventually coincides. Moreover, when the time further elapses, the temperature of the electric static chuck 213 is controlled by the refrigerant 214, and thus each of the wafer temperature and the ESC temperature decreases to the ESC initial temperature.

Thereafter, at time t2, plasma for etching is turned on. Then, the wafer WF is heated by heat flux from the plasma, and the wafer temperature rises. At this time, the ESC temperature also rises due to the heat transferred from the wafer WF. On the other hand, the wafer temperature and the ESC temperature are separated from each other, and the wafer temperature becomes higher than the ESC temperature.

Thereafter, at time t3, the plasma is turned off. Then, since the heat flux from the plasma is interrupted, each of the wafer temperature and the ESC temperature decreases. Then, each of the wafer temperature and the ESC temperature approaches and eventually coincides. As the time further elapses, each of the wafer temperature and the ESC temperature decreases to the ESC initial temperature.

As described above, the wafer temperature and the ESC temperature may deviate from each other during the process by the processing apparatus 200. Then, the process by the processing apparatus 200 may have dependency on the wafer temperature. Thus, in order to improve the stability of the process by the processing apparatus 200, it is more preferable to directly measure and manage the wafer temperature.

Note that FIG. 4 illustrates a case where there is a time during which the wafer temperature and the ESC temperature coincide with each other during the process, but the embodiment is not limited thereto. For example, in a case where weak plasma is generated for supplying electric charges for a wafer chuck in a period between time t1 and time t2, weak heat flux flows in, and the wafer WF is weakly heated. In this case, in the period between time t1 and time t2, although the wafer temperature approaches the ESC temperature, the wafer temperature and the ESC temperature do not coincide with each other and can be maintained in a close state.

### <1-2> Principle

Here, an example of the principle of temperature measurement and thickness measurement using optical interference will be described. Note that, in the present specification, a “substrate proximity layer” is defined as a layer in which the optical thickness from a substrate surface is thinner than half of an optical path length spread of planar Gaussian as illustrated in (B) of FIG. 19 described later. The substrate proximity layer may be a single layer, or may include a plurality of layers in which the total optical thickness satisfies the above condition. The substrate proximity layer may include not only a layer constituted by a substance but also a vacuum layer and an air gap. The substrate proximity layer may be generated not only on the front surface but also on the back surface of the substrate. Among the substrate proximity layers, those that become disturbance are layers whose optical thicknesses change during the process.

### First Example

In the first example, a case where the wafer WF as a measurement target is a single layer and temperature measurement is executed based on a peak position of a complex amplitude will be described.

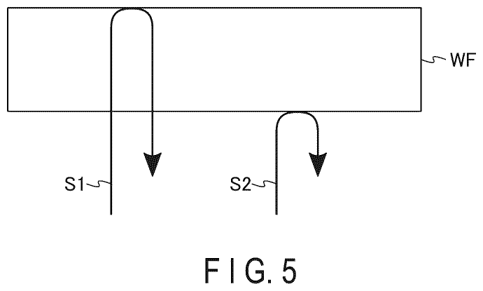

FIG. 5 is a diagram illustrating an example of a component of interference light in a case where the wafer WF as a measurement target is a single layer. As illustrated in FIG. 5, in the present example, the wafer WF is a single-layer silicon substrate and does not have a substrate proximity layer. At this time, the interference light is formed by interference between a signal component S1 and a signal component S2. The signal component S1 corresponds to reflected light from the surface of the wafer WF. The signal component S2 corresponds to reflected light from the back surface of the wafer WF.

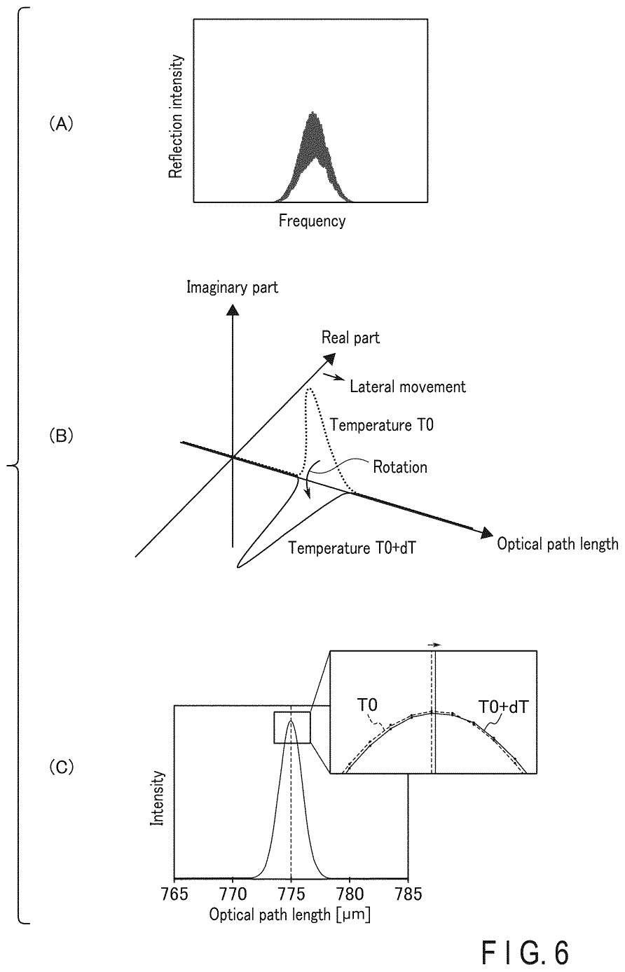

FIG. 6 is a diagram illustrating an outline of wafer temperature measurement using optical interference in the first example. (A) of FIG. 6 illustrates an interference spectrum measured by the spectrometer 140. In a graph illustrated in (A) of FIG. 6, the horizontal axis indicates frequency, and the vertical axis indicates reflection intensity. (B) of FIG. 6 is a waveform after Fourier transform or inverse Fourier transform of the interference spectrum illustrated in (A) of FIG. 6. Three axes of the graph illustrated in (B) of FIG. 6 indicate an optical path length [μm], a real part, and an imaginary part, respectively. The real part and the imaginary part indicate complex amplitudes based on the interference spectrum. (C) of FIG. 6 is a waveform obtained by calculating the absolute value of intensity of the interference spectrum after the Fourier transform illustrated in (B) of FIG. 6. In a graph illustrated in (C) of FIG. 6, the horizontal axis indicates the optical path length [μm], and the vertical axis indicates the intensity (absolute value of complex amplitude).

FIG. 6 illustrates a case where the wafer temperature measurement is executed on the single-layer wafer WF illustrated in FIG. 5 based on the peak position of the complex amplitude. If spectrometry is performed on interference light obtained by irradiating the wafer WF as a measurement target with measurement light, an interference spectrum as illustrated in (A) of FIG. 6 is obtained at a certain time. If the Fourier transform is performed on this interference spectrum, a waveform (complex amplitude data) indicated by a broken line in (B) of FIG. 6 is obtained. In this example, the wafer temperature when this waveform is acquired is TO. If the wafer temperature changes from T0 to T0+dT, the waveform laterally moves along the axis of the optical path length while rotating counterclockwise around the axis of the optical path length accompanying thermal expansion or a change in refractive index of the wafer WF. As a result, as illustrated in (C) of FIG. 6, the peak position of the complex amplitude based on the interference spectrum changes. As described above, the change amount of the peak position of the complex amplitude has a proportional relationship with the change amount dT of the wafer temperature. Thus, the change amount dT of the wafer temperature can be calculated based on the change amount of the peak position of the complex amplitude.

### Second Example

In the second example, a case where the wafer WF as a measurement target has a proximity layer and temperature measurement is executed based on the peak position of the complex amplitude will be described.

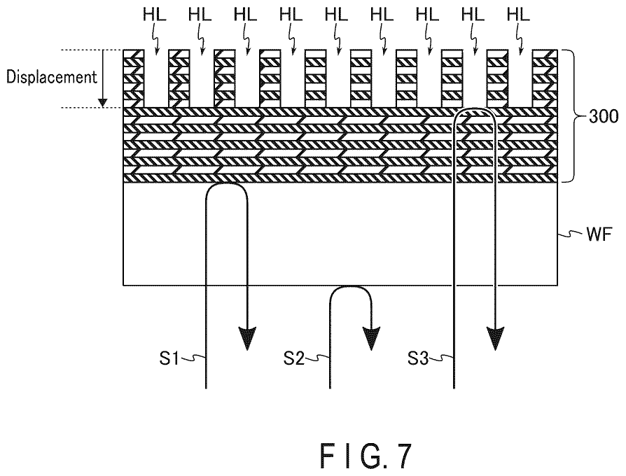

FIG. 7 is a diagram illustrating an example of a component of interference light in a case where the wafer WF as a measurement target has a proximity layer. As illustrated in FIG. 7, in the present example, a proximity layer 300 is formed on the wafer WF. The proximity layer 300 has, for example, a structure in which two types of members are alternately stacked. The proximity layer 300 may be, for example, a single layer. In the present example, a plurality of holes HL is formed in the proximity layer 300 by a process by the processing apparatus 200. That is, the position of the bottom of each hole HL changes during the process in the processing apparatus 200. In this case, the interference light is formed by the signal component S1, the signal component S2, and a noise component S3 interfering with each other. Each of the signal components S1 and S2 is similar to the content described in the first example. The noise component S3 corresponds to reflected light from the bottoms of the plurality of holes HL where displacement occurs during the process in the processing apparatus 200. Hereinafter, a signal component obtained by combining the signal components S1 and S2 is referred to as a signal component SC, and the noise component S3 is referred to as a noise component NC.

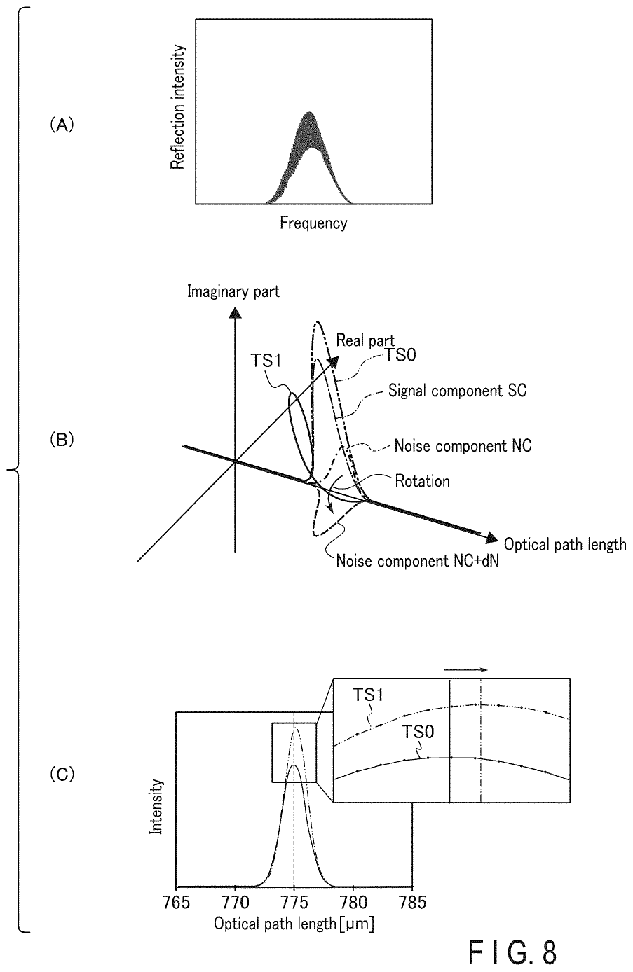

FIG. 8 is a diagram illustrating an outline of a method of measuring a wafer temperature using optical interference in a second example. (A) of FIG. 8 illustrates an interference spectrum measured by the spectrometer 140. In a graph illustrated in (A) of FIG. 8, the horizontal axis indicates frequency, and the vertical axis indicates reflection intensity. (B) of FIG. 8 is a waveform after Fourier transform or inverse Fourier transform of the interference spectrum illustrated in (A) of FIG. 8. Three axes of the graph illustrated in (B) of FIG. 8 indicate an optical path length [μm], a real part, and an imaginary part, respectively. The real part and the imaginary part indicate complex amplitudes based on the interference spectrum. (C) of FIG. 8 is a waveform obtained by calculating the absolute value of intensity of the interference spectrum after the Fourier transform illustrated in (B) of FIG. 8. In the graph illustrated in (C) of FIG. 8, the horizontal axis indicates the optical path length [μm], and the vertical axis indicates the intensity (absolute value of complex amplitude).

FIG. 8 illustrates a case where temperature measurement based on the peak position of the complex amplitude is executed on the wafer WF having the proximity layer 300 illustrated in FIG. 7 by a method similar to the first example, and only the noise component changes at the same temperature. If spectrometry is performed on interference light obtained by irradiating the wafer WF as a measurement target with measurement light, an interference spectrum as illustrated in (A) of FIG. 8 is obtained at a certain time. If the Fourier transform is performed on this interference spectrum, an observation signal TS0 indicated by a two-dot chain line in (B) of FIG. 8 is obtained. The observation signal TS0 corresponds to a waveform in which the signal component SC indicated by a one-dot chain line and the noise component NC are combined.

As the process in the processing apparatus 200 proceeds, the noise component NC changes to NC+dN indicated by a broken line accompanying a change in the structure of the proximity layer 300. If the noise component NC changes to NC+dN under the same temperature condition, an observation signal TS1 indicated by a solid line is obtained. The observation signal TS1 corresponds to a waveform in which the signal component SC and the noise component NC+dN are combined. Respective peak positions of the observation signals TS0 and TS1 are shifted as illustrated in (C) of FIG. 8. As described above, even in a case where the wafer temperature does not change, the peak position of the observation signal TS can laterally move along the axis of the optical path length according to the change in the proximity layer 300. That is, in the temperature measurement based on the peak position of the complex amplitude, an error in the measured temperature may occur based on a change in the noise component NC.

### Third Example

In a third example, in addition to the principle described in the first example and the second example, a case where temperature measurement based on a phase angle of a complex amplitude is executed will be described.

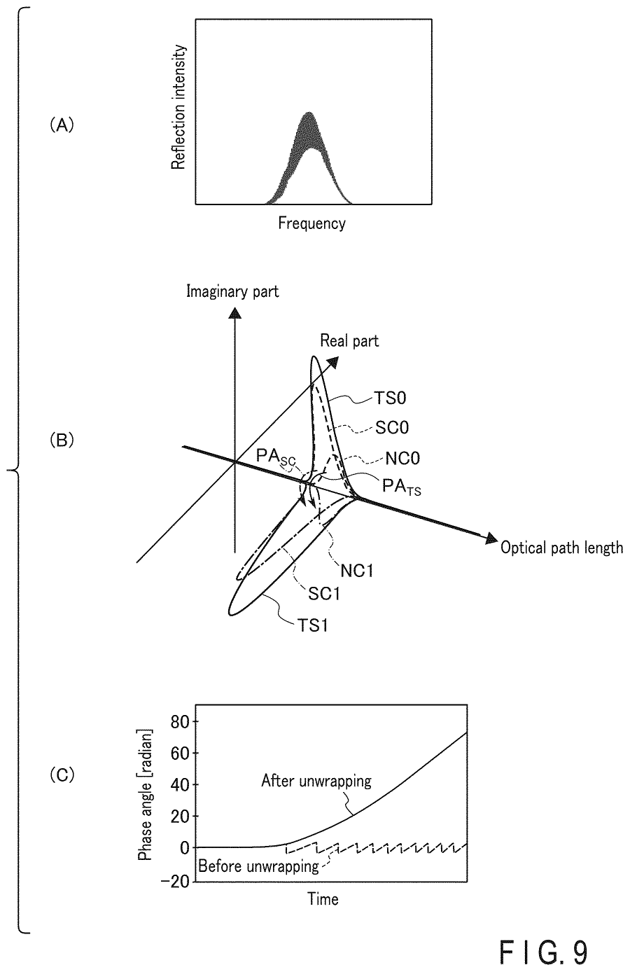

FIG. 9 is a diagram illustrating an outline of a method of measuring a wafer temperature using optical interference in the third example. (A) of FIG. 9 illustrates an interference spectrum measured by the spectrometer 140. In the graph illustrated in (A) of FIG. 9, the horizontal axis indicates frequency, and the vertical axis indicates reflection intensity. (B) of FIG. 9 is a waveform after Fourier transform and phase angle extraction of the interference spectrum illustrated in (A) of FIG. 9. Three axes of the graph illustrated in (B) of FIG. 9 indicate an optical path length [μm], a real part, and an imaginary part, respectively. The real part and the imaginary part indicate complex amplitudes based on the interference spectrum. (C) of FIG. 9 illustrates a change in the phase angle of the interference spectrum after the Fourier transform illustrated in (B) of FIG. 9. In the graph illustrated in (C) of FIG. 9, the horizontal axis indicates time and the vertical axis indicates the phase angle [radian].

FIG. 9 illustrates a case where a temperature change occurs during the process for the wafer WF having the proximity layer 300 illustrated in FIG. 7. If spectrometry is performed on interference light obtained by irradiating the wafer WF as a measurement target with measurement light, an interference spectrum as illustrated in (A) of FIG. 9 is obtained at a certain time. If the Fourier transform is performed on this interference spectrum, an observation signal TS0 indicated by a solid line in (B) of FIG. 9 is obtained. The observation signal TS0 corresponds to a waveform in which the signal component SC0 and the noise component NC0 indicated by a broken line are combined. Then, as the process in the processing apparatus 200 proceeds, the signal component changes to SC1 and the noise component changes to NC1 accompanying the change in the structure of the proximity layer 300. The observation signal TS1 corresponds to a waveform in which the signal component SC1 and the noise component NC1 indicated by a wo-dot chain line are combined. At this time, a change amount PA_{SC} of the phase angle between the signal components SC0 and SC1 is substantially the same as a change amount PA_{TS} of the phase angle between the observation signals TS0 and TS1. That is, the influence of the noise component NC on the change amount of the phase angle with respect to the observation signal is negligibly small. The sensitivity to temperature is higher in the temperature measurement based on the phase angle than in the temperature measurement based on the peak position.

In the third example, the change amount in the wafer temperature is derived by focusing on the correlation between the change amount in the phase angle of the observation signal TS and the change amount in the wafer temperature. Note that, as indicated by a broken line in (C) of FIG. 9, the phase angle returns to −π with a period of 2π (before unwrapping). Thus, in the third example, unwrapping processing (that is, phase recovery processing) of the phase angle is executed in order to derive an accurate change amount of the phase angle. As a result, as indicated by a solid line in (C) of FIG. 9, a continuous change amount of the phase angle is derived. Thus, in the third example, by measuring and calculating the phase angle for each measurement time, the change amount of the wafer temperature can be calculated based on the change amount of the phase angle.

Note that, in the first to third examples, the case where the wafer temperature is derived based on the measured interference spectrum has been exemplified, but these methods can also be applied to deriving the wafer thickness (also referred to as wafer film thickness). For example, the change amount in the wafer thickness can be converted from the wafer temperature based on information such as the thermal expansion coefficient of the wafer. Further, the wafer thickness can be converted from the optical path length obtained from the measured interference spectrum. The “thickness” in each process described in this specification may be replaced with an “optical path length”.

### <1-3> Measuring Method

Hereinafter, as a method of manufacturing a semiconductor device, a method of measuring a wafer thickness by the measuring apparatus 100 according to the first embodiment will be described. The method for measuring the wafer thickness according to the first embodiment uses the principle described in the first to third examples. The method of measuring the wafer thickness according to the first embodiment includes, for example, sampling of a measurement result to be described later, preliminary preparation, and measurement processing.

### <1-3-1> Method of Sampling Measurement Result

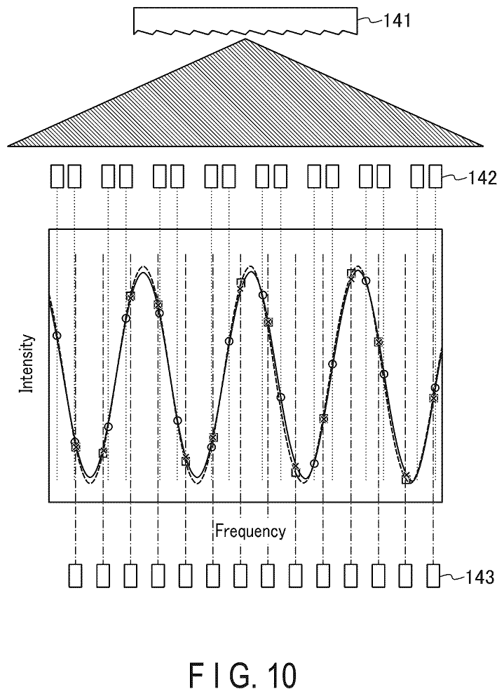

FIG. 10 is a diagram illustrating an example of a method of sampling a measurement result by the spectrometer 140 included in the measuring apparatus 100 according to the first embodiment. As illustrated in FIG. 10, the spectrometer 140 includes a diffraction grating 141 and a plurality of spectrometer sensors 142. The diffraction grating 141 separates interference light guided from the optical system 120 (see FIG. 1) into light of different wavelengths using diffraction and guides the light to the plurality of spectrometer sensors 142. Each of the plurality of spectrometer sensors 142 detects light having an associated wavelength. In the present example, the plurality of spectrometer sensors 142 may not be arranged at equal intervals. In other words, the channel intervals in the spectrometer 140 may not be equal intervals. As a condition for enabling the Fourier transform, for example, the horizontal axes of the spectral waveforms need to be at equal frequency intervals. Therefore, in a case where the channel intervals in the spectrometer 140 are not equal intervals, it is necessary to perform resampling and make the channel intervals equal.

FIG. 10 is a graph illustrating detection results by the plurality of spectrometer sensors 142. The horizontal axis of this graph represents frequency, and the vertical axis represents intensity. The plurality of plots indicated by “o” in the graph correspond to detection results by the plurality of spectrometer sensors 142. Hereinafter, an ideal sine wave by the plurality of spectrometer sensors 142 is adopted as a true value curve (broken line in the drawing), and a deviation from the ideal value by resampling will be described. The calculator 150 generates a resampling curve by spline interpolation in order to make the horizontal axis of the spectral waveform at equal frequency intervals. In FIG. 10, a resampling curve generated by spline interpolation is indicated by a solid line. Further, in FIG. 10, virtual positions of the plurality of spectrometer sensors 142 in the case of resampling are schematically illustrated as the plurality of spectrometer sensors 143. The plurality of plots indicated by “x” in the graph correspond to detection results by the plurality of spectrometer sensors 143. By resampling, the channel intervals become equal intervals, and Fourier transform becomes possible. However, a deviation may occur between a true value curve (broken line in the drawing) and a resampling curve (solid line in the drawing) generated by spline interpolation. That is, the value after resampling (x mark in the drawing) may be slightly different from the ideal value (Q mark in the drawing). As a result, a shift of the peak position of the complex amplitude obtained by the Fourier transform occurs, and an error may occur in the measurement value of the thickness.

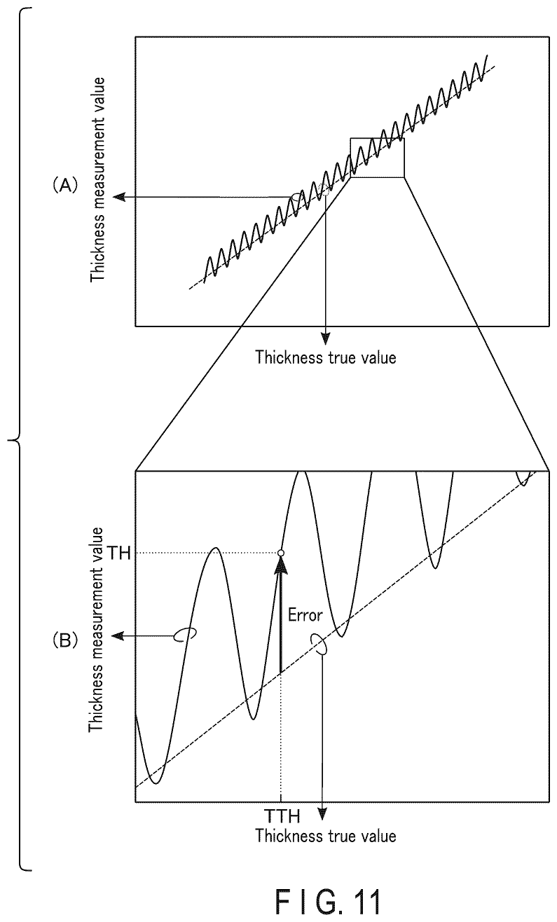

FIG. 11 is a diagram illustrating an example of a measurement error in the spectrometer 140 included in the measuring apparatus 100 according to the first embodiment. (A) and (B) of FIG. 11 illustrate the relationship between a thickness true value (horizontal axis) representing a true value of the thickness and a thickness measurement value (vertical axis) representing measurement values of the thickness measured by the plurality of spectrometer sensors 142 of the spectrometer 140. (B) of FIG. 11 illustrates (A) of FIG. 11 in an enlarged manner. As illustrated in FIG. 11, the thickness measurement values includes a periodic error with respect to the true value due to resampling of the spectral waveform. Specifically, the difference between the illustrated thickness true value TTH and the thickness measurement value TH corresponds to the error. In order to derive the thickness true value, an estimation of the amount of error in the thickness measurement value at a certain moment is required.

### <1-3-2> Preliminary Preparation

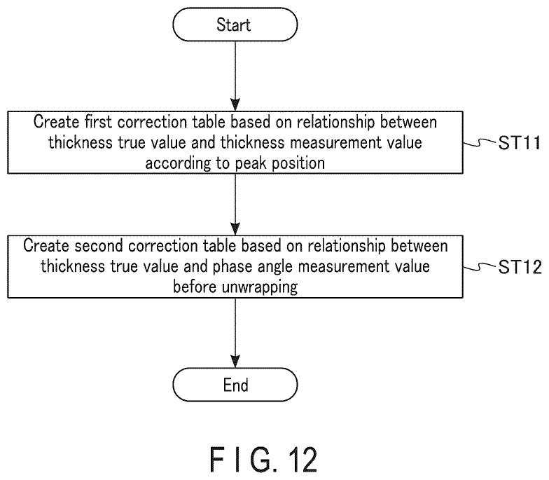

FIG. 12 is a flowchart illustrating an example of preliminary preparation for measurement processing by the measuring apparatus 100 according to the first embodiment. As illustrated in FIG. 12, in the preliminary preparation, the processing of steps ST11 and ST12 is sequentially executed.

### (Step ST11)

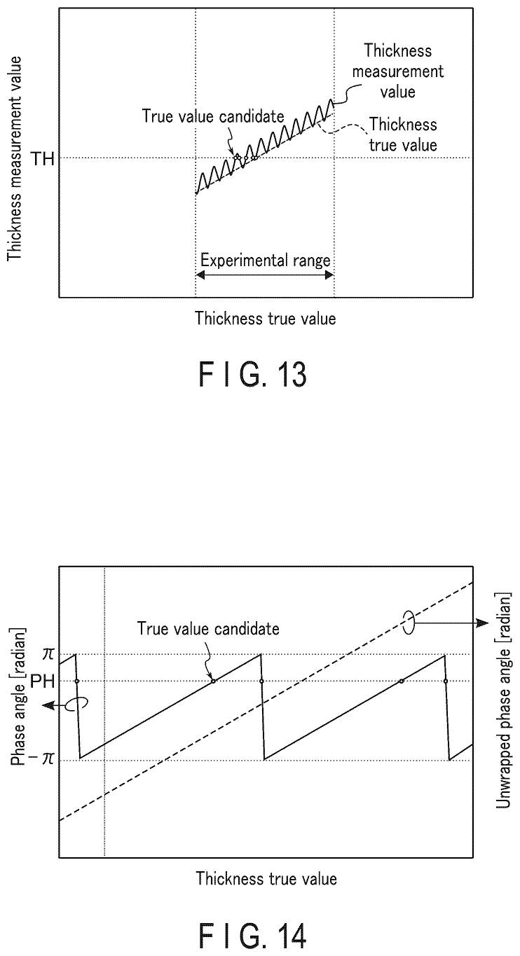

In step ST11, the calculator 150 creates a first correction table based on the relationship between the thickness true value and the thickness measurement value according to the peak position of the waveform after the Fourier transform. FIG. 13 is a diagram illustrating an example of the first correction table generated by the measuring apparatus 100 according to the first embodiment. The horizontal axis indicates the thickness true value, and the vertical axis indicates the thickness measurement value.

The first correction table is created by an experiment using the principle illustrated in FIGS. 6 and 8, for example. For example, the spectrometer 140 measures the spectroscopic spectrum waveform of the light reflected from the measurement target object under a plurality of temperature conditions. This plurality of temperature conditions corresponds to a “experimental range”. Then, the calculator 150 calculates the thickness measurement value based on the peak position of the complex amplitude derived from the measured spectroscopic spectrum waveform. Further, the calculator 150 calculates (estimates) a thickness true value based on the thermal expansion coefficient of the measurement target object. Then, the calculator 150 creates a correlation graph between the thickness true value and the thickness measurement value by associating the calculated thickness true value with the thickness measurement value.

The correlation graph created in this manner corresponds to the first correction table. The first correction table stores candidates for the thickness true value corresponding to the peak position of the complex amplitude (waveform) obtained from the measurement result of the spectrometer 140. The first correction table is stored in the storage device 155, for example. In the measurement processing to be described later, the first correction table read into the RAM 153 may be used. There may be a plurality of candidates for the thickness true value. By using the first correction table, the measuring apparatus 100 can list a plurality of candidates for the thickness true value based on the thickness measurement value TH obtained from the peak position of the complex amplitude. In other words, the measuring apparatus 100 can extract a plurality of thickness true value candidates associated with the thickness corresponding to the thickness measurement value TH from the first correction table. Note that the first correction table may be a mathematical expression indicating the relationship between the thickness true value and the peak position of the complex amplitude.

### (Step ST12)

In step ST12, the calculator 150 creates a second correction table based on the relationship between the thickness true value and the measurement value of the phase angle before unwrapping. FIG. 14 is a diagram illustrating an example of the second correction table generated by the measuring apparatus 100 according to the first embodiment. The horizontal axis indicates the thickness true value, and the vertical axis indicates the phase angle [radian] or the unwrapped phase angle [radian].

The second correction table is created by an experiment using the principle illustrated in FIG. 9, for example. In the experiment, the measuring apparatus 100 measures a plurality of sets of the thickness true value and the phase angle of the complex amplitude. The thickness true value may be calculated (estimated) based on the thermal expansion coefficient of the measurement target object, or may be calculated (estimated) based on the unwrapped phase angle. Thereafter, the calculator 150 creates a correlation graph between the thickness true value and the phase angle by associating the calculated thickness true value and the phase angle.

The correlation graph created in this manner corresponds to the second correction table. The second correction table stores candidates for the thickness true value corresponding to the phase angle of the complex amplitude (waveform) obtained from the measurement result of the spectrometer 140. The second correction table is stored in the storage device 155, for example. In the measurement processing to be described later, the second correction table read into the RAM 153 may be used. Since the phase angle used in the second correction table is the phase angle before unwrapping, the phase angle is in the range of −π to π [radian]. There may be a plurality of candidates for the thickness true value. By using the second correction table, the measuring apparatus 100 can list a plurality of thickness true value candidates based on the phase angle PH of the complex amplitude. Note that the second correction table may be a mathematical expression indicating the relationship between the thickness true value and the phase angle.

In the above description, the case where the experiment for generating the first correction table and the experiment for generating the second correction table are different has been exemplified, but these experiments may be collectively executed. That is, the calculator 150 of the measuring apparatus 100 according to the first embodiment can generate the first correction table and the second correction table based on experimental results in a predetermined experimental range. Further, a measurement object in a target semiconductor manufacturing process is used for generating the first correction table and the second correction table. That is, each of the first correction table and the second correction table is prepared for each target semiconductor manufacturing process and used in the measurement processing in the associated semiconductor manufacturing process.

### <1-3-3> Measurement Processing

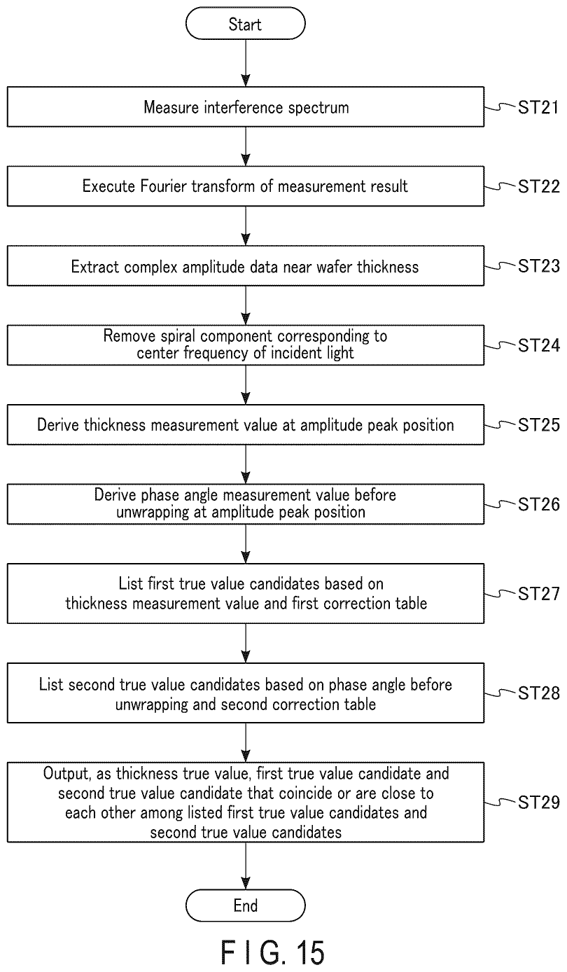

FIG. 15 is a flowchart illustrating an example of measurement processing by the measuring apparatus 100 according to the first embodiment. As illustrated in FIG. 15, in the measurement processing, processing of steps ST21 to ST29 is sequentially executed. Note that the measurement processing can be executed during the process of the measurement target object, that is, in a state where the structure of the measurement target object changes. That is, for example, the wafer WF to be processed by the processing apparatus 200 is the measurement target object.

### (Step ST21)

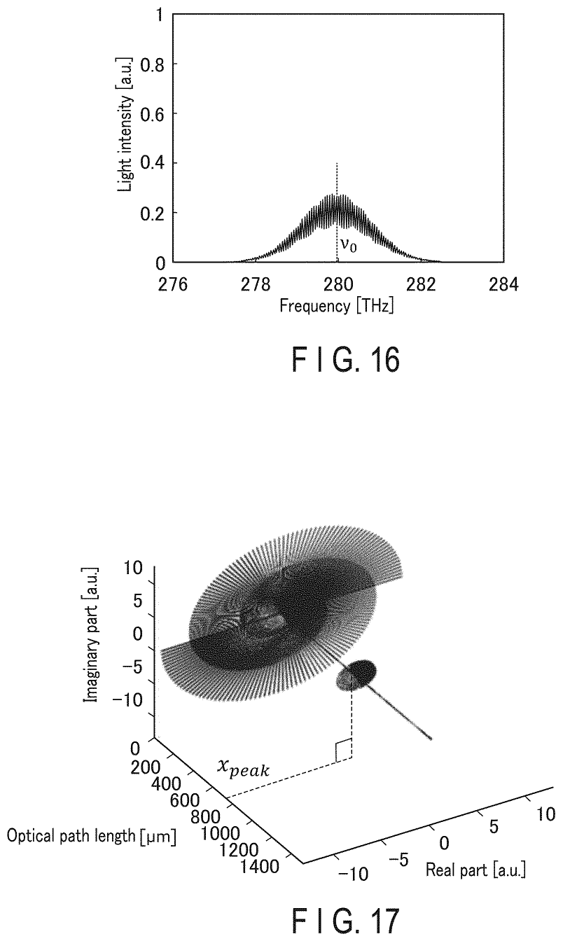

In step ST21, the spectrometer 140 of the measuring apparatus 100 measures an interference spectrum. FIG. 16 is a diagram illustrating an example of an interference spectrum measured by the measuring apparatus 100 according to the first embodiment. The horizontal axis of the graph indicates frequency [THz], and the vertical axis of the graph indicates light intensity [a. u.]. If light in which reflected light from the upper layer and the lower layer of the wafer WF interferes is input to the spectrometer 140, the spectrometer 140 can measure an interference spectrum as illustrated in FIG. 16. v₀ illustrated in FIG. 16 corresponds to the center frequency of the interference light.

### (Step ST22)

In step ST22, the calculator 150 of the measuring apparatus 100 executes Fourier transform of the measurement result. Specifically, the calculator 150 performs zero fill processing on the interference spectrum on which the interpolation processing has been performed, and executes Fourier transform. FIG. 17 is a diagram illustrating an example of a complex amplitude obtained by Fourier transform of the measuring apparatus 100 according to the first embodiment. Three axes of the graph indicate an optical path length [μm], a real part [a. u.], and an imaginary part [a. u.], respectively. As illustrated in FIG. 17, the calculator 150 can obtain complex amplitude data including complex numbers based on the acquired interference spectrum in step ST23. At this point, the complex amplitude data includes a spiral component. Note that xₚₑₐₖ illustrated in FIG. 17 indicates an optical path length corresponding to the peak of the thickness of the wafer WF.

### (Step ST23)

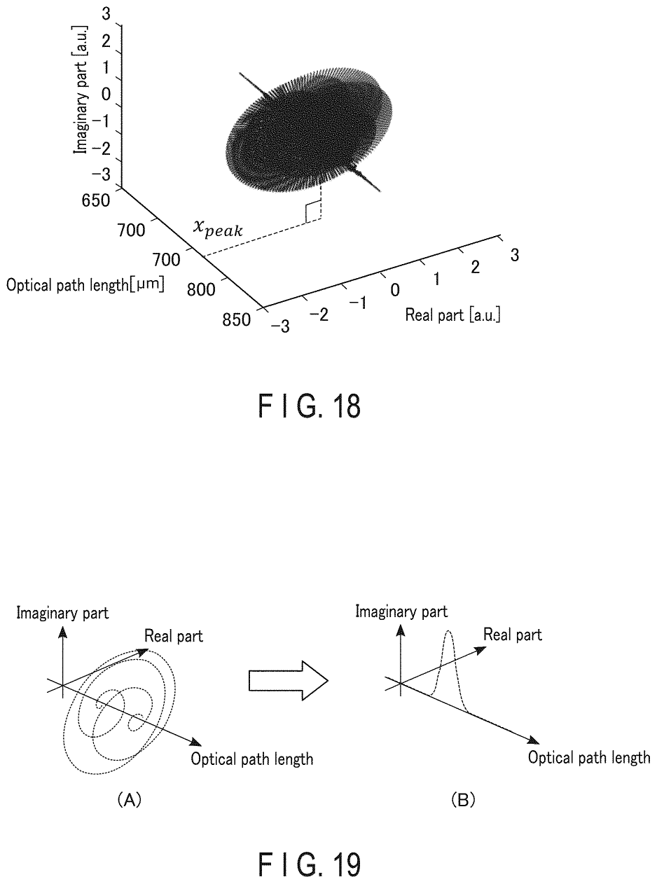

In step ST23, the calculator 150 of the measuring apparatus 100 extracts (cuts out) complex amplitude data near the wafer thickness. That is, the waveform around the frequency corresponding to the wafer thickness is extracted from the Fourier-transformed waveform. The thickness of the 300 mm silicon wafer is, for example, about 750 μm. FIG. 18 is a diagram illustrating an example of the complex amplitude near a wafer thickness extracted by the measuring apparatus 100 according to the first embodiment. Three axes of the graph indicate an optical path length [μm], a real part [a. u.], and an imaginary part [a. u.], respectively. As illustrated in FIG. 18, the calculator 150 can extract complex amplitude data near the optical path length (near xₚₑₐₖ) corresponding to the peak of the wafer thickness in step ST23. The extracted complex amplitude data includes a spiral component.

### (Step ST24)

In step ST24, the calculator 150 of the measuring apparatus 100 removes a spiral component corresponding to the center frequency v₀ of the incident light. FIG. 19 is a diagram illustrating an example of complex amplitudes before and after removal of a spiral component by the measuring apparatus 100 according to the first embodiment. Three axes of the graph indicate an optical path length, a real part, and an imaginary part, respectively. (A) of FIG. 19 illustrates an image of complex amplitude data before removal of the spiral component. (B) of FIG. 19 illustrates an image of complex amplitude data after removal of the spiral component.

The extracted complex amplitude has a spiral waveform as illustrated in (A) of FIG. 19. In step ST25, first, the calculator 150 calculates a phase angle measurement value of the complex amplitude component at each optical path length. Then, the calculator 150 performs processing of rewinding the complex amplitude in each optical path length around the axis of the optical path length using the calculated phase angle measurement value. Thus, the calculator 150 can align the phase angles in the respective optical path lengths, and can obtain a planar Gaussian waveform as illustrated in (B) of FIG. 19.

In the present specification, such processing is referred to as removal of the helical component of the phase. The set of phase angles used for rewinding is called a phase angle data set. The calculator 150 may obtain the phase angle data set in advance from spectroscopic spectrum data using a bare silicon wafer, instead of obtaining the phase angle data set in each sampling step of the wafer thickness measurement. Thus, the calculator 150 can execute a rewinding process in each sampling step of the interference spectrum using the phase angle data set obtained in advance.

Note that, in a case where the disturbance from the substrate proximity layer is small in the wafer as a target of wafer thickness measurement, the calculator 150 may obtain the phase angle data set from the data of the interference spectrum obtained at the start of the processing of performing the wafer thickness measurement.

### (Step ST25)

In step ST25, the calculator 150 of the measuring apparatus 100 derives the thickness measurement value at the amplitude peak position. The calculator 150 holds the derived measurement value of the thickness in, for example, the RAM 153.

### (Step ST26)

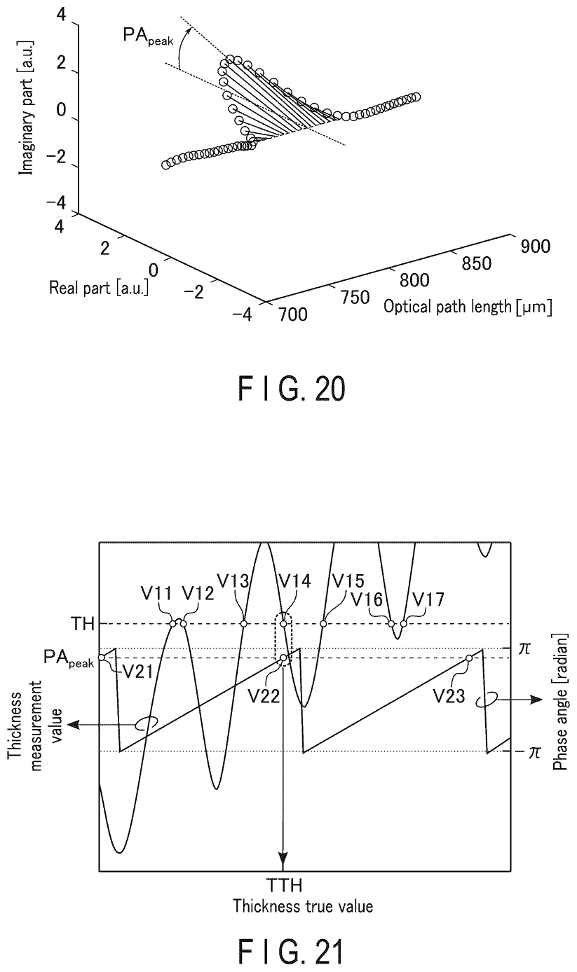

In step ST26, the calculator 150 of the measuring apparatus 100 derives the phase angle measurement value at the amplitude peak position. FIG. 20 is a diagram illustrating an example of a planar Gaussian waveform and a phase angle corresponding to an amplitude peak position by the measuring apparatus 100 according to the first embodiment. Three axes of the graph indicate an optical path length [μm], a real part [a. u.], and an imaginary part [a. u.], respectively. As illustrated in FIG. 20, the calculator 150 can calculate the phase angle PAₚₑₐₖ near the peak position of the complex amplitude. The calculator 150 holds the derived phase angle in, for example, the RAM 153. Note that, as the phase angle PAₚₑₐₖ, a phase angle between the plane including the planar Gaussian and the axis of the real part may be used, or a phase angle between the plane including the planar Gaussian and the axis of the imaginary part may be used.

### (Step ST27)

In step ST27, the calculator 150 of the measuring apparatus 100 lists (extracts) first true value candidates based on the thickness measurement value and the first correction table. The first true value candidate corresponds to a thickness true value candidate associated with the thickness corresponding to the thickness measurement value derived in step ST25 in the first correction table. There may be a plurality of first true value candidates.

### (Step ST28)

In step ST28, the calculator 150 of the measuring apparatus 100 lists (extracts) second true value candidates based on the phase angle before unwrapping and the second correction table. The second true value candidate corresponds to a thickness true value candidate associated with the thickness corresponding to the phase angle measurement value derived in step ST26 in the second correction table. There may be a plurality of second true value candidates.

### (Step ST29)

In step ST29, the calculator 150 of the measuring apparatus 100 outputs, as the thickness true value, a first true value candidate and a second true value candidate that coincide or are close to each other among the listed first true value candidates and second true value candidates. FIG. 21 is a diagram illustrating a method of selecting a thickness true value by the measuring apparatus according to the first embodiment. FIG. 21 illustrates the first correction table and the second correction table in an overlapping manner. As illustrated in FIG. 21, in the present example, the first true value candidates derived from the thickness measurement value TH using the first correction table include V11 to V17. Further, the calculator 150 calculates that the second true value candidates derived from the phase angle PAₚₑₐₖ using the second correction table include V21 to V23. In this example, the first true value candidate V14 and the second true value candidate V22 have substantially the same numerical value of the thickness true value TTH. Therefore, in the present example, the calculator 150 outputs the first true value candidate V14 and the second true value candidate V22 as the thickness true value TTH.

Note that when the first true value candidate V14 and the second true value candidate V22 are not the same but are the closest values, the calculator 150 may output either the first true value candidate V14 or the second true value candidate V22 as the thickness true value TTH. In addition, the calculator 150 may output a value (for example, an average value) calculated based on the first true value candidate V14 and the second true value candidate V22 as the thickness true value TTH.

Note that, in the above description, the case where the calculator 150 of the measuring apparatus 100 derives the waveform of the complex amplitude by Fourier transform of the interference spectrum has been described, but the embodiment is not limited thereto. In the measurement processing, the processing corresponding to the Fourier transform may be replaced with the inverse Fourier transform. Even in such a case, the measuring apparatus 100 can calculate the wafer thickness based on the waveform peak and the phase angle of the complex amplitude.

### <1-4> Advantageous Effects of First Embodiment

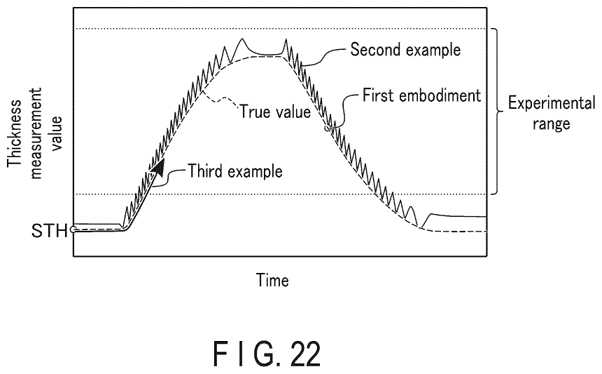

FIG. 22 is a diagram describing advantages of the measuring method by the measuring apparatus 100 according to the first embodiment. FIG. 22 illustrates a case where the wafer thickness is measured using each of the second example, the third example, and the first embodiment described above in a case where the wafer is heated by a thermocouple and the wafer thickness changes with time. Further, the value converted from temperature data of the thermocouple to the wafer thickness is illustrated as a true value. Hereinafter, advantageous effects of the first embodiment will be described with reference to FIG. 22.

The measurement result in a case where the thickness measurement is performed based on the peak position of the complex amplitude as in the second example has undulation. Therefore, in the second example, the thickness cannot be uniquely obtained from the measurement value of the thickness. The measurement result when the thickness measurement is performed using the unwrapped phase angle as in the third example is close to the true value. On the other hand, in the third example, information of a thickness STH at the start of the process and continuous measurement and calculation at a predetermined sampling interval are required.

On the other hand, the measuring apparatus 100 according to the first embodiment acquires the first correction table indicating the relationship between the thickness true value and the thickness measurement value by the peak position and the second correction table indicating the relationship between the thickness true value and the phase angle measurement value before unwrapping in advance by experiment. Then, the measuring apparatus 100 uses the measurement result of the interference spectrum corresponding to the light reflected from the measurement target object of thickness to acquire a plurality of first true value candidates from the first correction table, and acquires a plurality of second true value candidates from the second correction table. Then, the measuring apparatus 100 adopts, as the thickness true value, ones that coincide or are close to each other among the acquired first true value candidates and the acquired second true value candidates.

As described above, the measuring apparatus 100 according to the first embodiment can uniquely determine the thickness true value by measuring one point. Then, the measuring apparatus 100 according to the first embodiment can correct an error in the thickness measurement value by deriving the thickness true value using the first correction table and the second correction table. Thus, a measurement error caused by sensor intervals of the spectrometer 140 not being equal can be reduced. Therefore, the measuring apparatus 100 according to the first embodiment can reduce an error in thickness measurement using optical interference.

Note that, in the measuring apparatus 100 according to the first embodiment, the range in which the thickness true value can be obtained by measuring one point is limited to the experimental range. Therefore, in the measuring apparatus 100 according to the first embodiment, it is required to set the experimental range so as to include an expected change in the thickness of the measurement target object for each semiconductor manufacturing process of the thickness measurement target. Therefore, in a second embodiment, a method of extending the first correction table and the second correction table outside the experimental range will be described.

### <2> Second Embodiment

A measuring apparatus 100 according to the second embodiment extrapolates the first correction table and the second correction table described in the first embodiment to the outside of the experimental range.

Hereinafter, details of the measuring apparatus 100 according to the second embodiment will be mainly described on differences from the first embodiment.

### <2-1> Configuration

The configuration of the measuring apparatus 100 according to the second embodiment is similar to that of the first embodiment.

### <2-2> Measuring Method

Extrapolation of the first correction table and the second correction table to the outside of the experimental range can be performed by finding regularity among thickness measurement values from the peak position of the complex amplitude, measurement values of the phase angle before unwrapping, and thickness errors. Hereinafter, as a measuring method of the measuring apparatus 100 according to the second embodiment, a case will be described in which it is assumed that regularity among thickness measurement values from the peak position of the complex amplitude, measurement values of the phase angle before unwrapping, and thickness errors has periodicity, and extrapolation processing of the first correction table and the second correction table to the outside of the experimental range is executed.

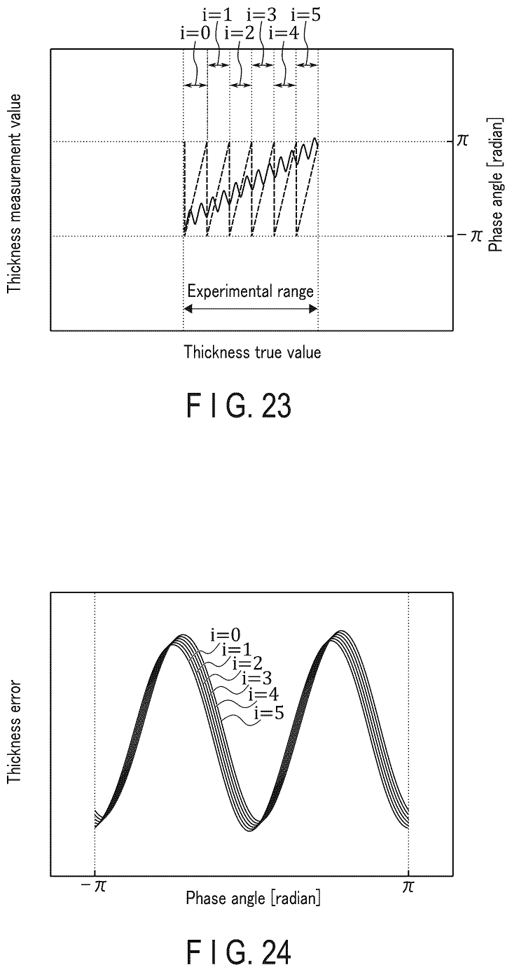

FIG. 23 is a diagram illustrating an example of an experimental result used in the extrapolation processing by the measuring apparatus 100 according to the second embodiment. FIG. 23 illustrates the experimental result (solid line in FIG. 23) of the first correction table obtained in step ST11 in FIG. 12 and the experimental result (broken line in FIG. 23) of the second correction table obtained in step ST12 in an overlapping manner. First, as illustrated in FIG. 23, the calculator 150 of the measuring apparatus 100 assigns the index i to each section where the phase angle before unwrapping is folded in the correction table obtained by an experiment in advance. In this example, the phase angle before unwrapping is folded six times in the experimental range. Therefore, the experimental range includes six sections to which the index i=0 to 5 is allocated.

When the relationship between the phase angle and the thickness error is plotted for each index i, FIG. 24 is obtained. FIG. 24 is a diagram illustrating a relationship between a phase angle and a thickness error obtained by extrapolation processing by the measuring apparatus 100 according to the second embodiment. The horizontal axis of the graph illustrated in FIG. 24 indicates the phase angle, and the vertical axis indicates the thickness error. Looking at the correlation between the phase angle and the thickness error, it is confirmed that curves having substantially the same shape slide slightly in the longitudinal direction and the lateral direction. Therefore, the graph illustrated in FIG. 24 is parametrically expressed as the following Expression (1).

$$\\ \begin{matrix}{\tilde{d}}_{err} = g ( {θ}_{raw} - i Δ {θ}_{raw} ) + i Δ {d}_{err} & ( 1 )\end{matrix}$$

~deᵣᵣ is an estimated value of the thickness error. g(θ) is a periodic function defined by [−π, π]. Δθ_{raw} and Δdₑᵣᵣ are fixed values, and a movement amount for translating g(θ) in the horizontal direction and the vertical direction is determined for each index i. The calculator 150 of the measuring apparatus 100 determines g(θ), Δθ_{raw}, and Δdₑᵣᵣ in Expression (1) so as to most coincide with the relationship between the phase angle and the thickness error illustrated in FIG. 24.

Next, extrapolation of a correction table (that is, the second correction table) of the phase angle before unwrapping will be considered. The unwrapped phase angle can be described as the following Expression (2) using the index i.

$$\\ \begin{matrix}θ = {θ}_{raw} + 2 π i & ( 2 )\end{matrix}$$

Further, it is assumed that the thickness true value d can be described by the phase angle θ after unwrapping as in the following Expression (3).

$$\\ \begin{matrix}d = f ( θ ) = f ( {θ}_{raw} + 2 π i ) & ( 3 )\end{matrix}$$

When θ_{raw}, is solved for the correction table, the following Expression (4) is obtained.

$$\\ \begin{matrix}{θ}_{raw} = {f}^{- 1} ( d ) - 2 π i & ( 4 )\end{matrix}$$

f⁻¹ represents an inverse function of the function f. For example, when expressed as a linear expression such as f(θ)=aθ+b, Expression (4) is expressed as the following Expression (5).

$$\\ \begin{matrix}{θ}_{raw} = \frac{d - b}{a} - 2 π i & ( 5 )\end{matrix}$$

Thus, since the phase angle before unwrapping can be expressed by the thickness true value d, extrapolation outside the experimental range in the second correction table becomes possible.

Next, extrapolation of a correction table (that is, the first correction table) of the thickness measurement value according to the peak position will be considered. When the thickness true value d is expressed by the thickness measurement value dₘₑₐ and the thickness error dₑᵣᵣ, the following Expression (6) is obtained.

$$\\ \begin{matrix}d = {d}_{mea} - {\tilde{d}}_{err} = {d}_{mea} - g ( {θ}_{raw} - i Δ {θ}_{raw} ) + i Δ {d}_{err} & ( 6 )\end{matrix}$$

When the Expression (4) is substituted into Expression (6), the following Expression (7) is obtained.

$$\\ \begin{matrix}d = {d}_{mea} - g ( {f}^{- 1} ( d ) - 2 π i - i Δ {θ}_{raw} ) - i Δ {d}_{err} = {d}_{mea} - g ( {f}^{- 1} ( d ) - i Δ {θ}_{raw} ) - i Δ {d}_{err} ∴ {d}_{mea} = d + g ( {f}^{- 1} ( d ) - i Δ {θ}_{raw} ) + i Δ {d}_{err} & ( 7 )\end{matrix}$$

Thus, since the thickness measurement value can be expressed by the thickness true value d, extrapolation outside the experimental range in the first correction table becomes possible.

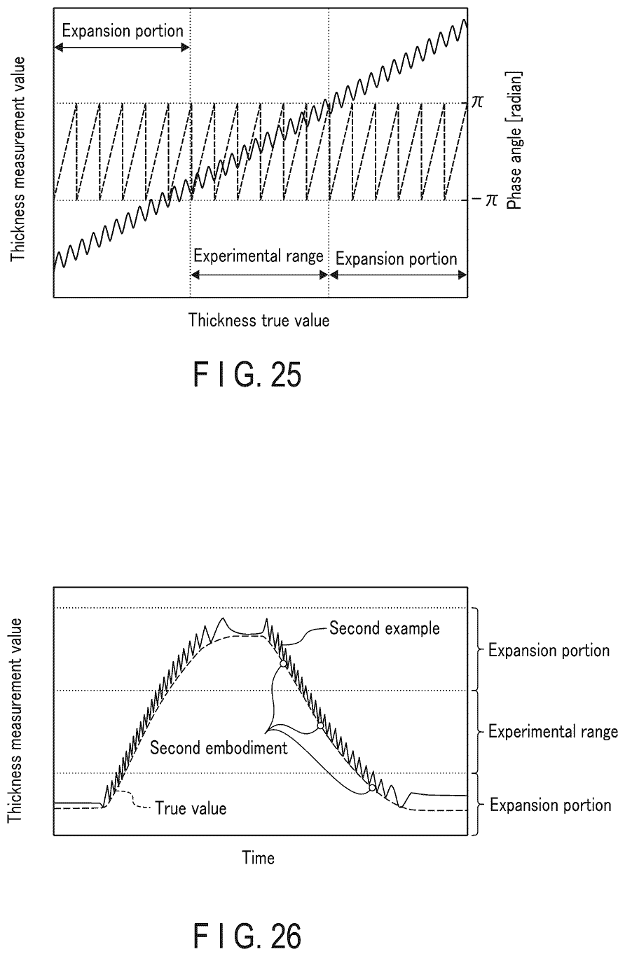

The measuring apparatus 100 according to the second embodiment can generate the first correction table and the second correction table extended outside the experimental range by performing the extrapolation processing described above. FIG. 25 is a diagram illustrating an example of the first correction table and the second correction table generated by the measuring apparatus 100 according to the second embodiment. In FIG. 25, a portion generated by the extrapolation processing in the first correction table and the second correction table is illustrated as an expansion portion. In the measuring apparatus 100 according to the second embodiment, the experimental range may be set at least to an extent that the extrapolation processing can be executed. The measuring apparatus 100 according to the second embodiment can increase the accuracy of the expansion portion as the experimental range is widened and the number of indexes in the extrapolation processing is increased.

### <2-3> Advantageous Effects of Second Embodiment

FIG. 26 is a diagram describing advantages of the measuring method by the measuring apparatus according to the second embodiment. FIG. 26 illustrates a case where the wafer thickness is measured using each of the second example and the second embodiment described above in a case where the wafer is heated by a thermocouple and the wafer thickness changes with time. Further, the value converted from temperature data of the thermocouple to the wafer thickness is illustrated as a true value. Hereinafter, advantageous effects of the second embodiment will be described with reference to FIG. 26.

In the measuring method described in the first embodiment, the measurement range is limited to the experimental range. On the other hand, the measuring apparatus 100 according to the second embodiment parametrically expresses the regularity among thickness measurement values from the peak position of the complex amplitude, measurement values of the phase angle before unwrapping, and thickness errors within the experimental range. Then, the measuring apparatus 100 extends the first correction table and the second correction table to the outside of the experimental range from the correlation between the phase angle and the thickness error obtained by searching for the parameter having the smallest difference from the experimental result.

As a result, as illustrated in FIG. 26, the measuring apparatus 100 according to the second embodiment can uniquely determine the thickness true value by measuring one point even in each expansion portion outside the experimental range as in the first embodiment. That is, the measurement range of the measuring apparatus 100 according to the second embodiment is not limited to the experimental range, and is wider than the experimental range by extrapolation of the first correction table and the second correction table. Then, the measurement error in the second embodiment can be reduced to about 1/10 of that in the second example. Therefore, the measuring apparatus 100 according to the second embodiment can correct errors as in the first embodiment, and can reduce errors in thickness measurement using optical interference.

Further, the measuring apparatus 100 according to the second embodiment can suppress the cost required for the experiment for creating the first correction table and the second correction table.

### <3> Third Embodiment

A third embodiment relates to a case where the measuring method described in the first embodiment is applied to temperature measurement of a wafer. Hereinafter, details of a measuring apparatus 100 according to the third embodiment will be mainly described on differences from the first and second embodiments.

### <3-1> Configuration

The configuration of the measuring apparatus 100 according to the third embodiment is similar to that of the first embodiment.

### <3-2> Measuring Method

Hereinafter, as a method of manufacturing a semiconductor device, a method of measuring a wafer temperature by the measuring apparatus 100 according to the third embodiment will be described.

### <3-2-1> Preliminary Preparation

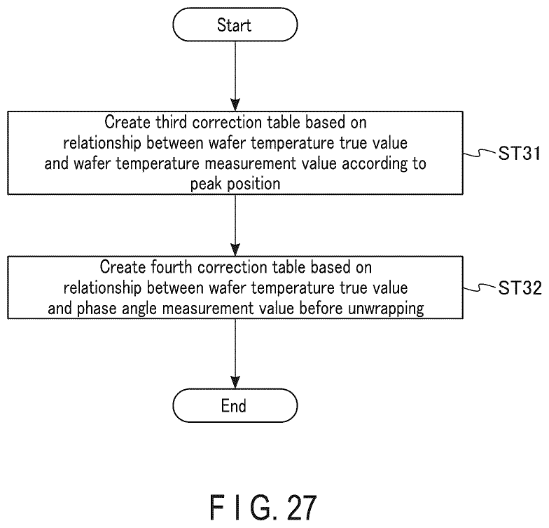

FIG. 27 is a flowchart illustrating an example of preliminary preparation for measurement processing by the measuring apparatus 100 according to the third embodiment. As illustrated in FIG. 27, in the preliminary preparation, the processing of steps ST31 and ST32 is sequentially executed.

### (Step ST31)

In step ST31, the calculator 150 creates a third correction table based on the relationship between the wafer temperature true value and the wafer temperature measurement value according to the peak position. Similarly to the first embodiment, the third correction table can be created by an experiment using the principle illustrated in FIGS. 6 and 8, for example. For example, the spectrometer 140 measures the spectroscopic spectrum waveform of the light reflected from the measurement target object under a plurality of temperature conditions. Then, the calculator 150 calculates the wafer temperature measurement value based on the peak position of the complex amplitude derived from the measured spectroscopic spectrum waveform. Then, the calculator 150 creates a correlation graph between the wafer temperature true value and the wafer temperature measurement value by associating the wafer temperature true value and the wafer temperature measurement value with each other.

The correlation graph created in this manner corresponds to the third correction table. The third correction table stores a candidate of the wafer temperature true value associated with the temperature corresponding to the wafer temperature measurement value corresponding to the peak position of the complex amplitude obtained from the measurement result of the spectrometer 140. The third correction table is stored in the storage device 155, for example. There may be a plurality of candidates for the wafer temperature true value. By using the third correction table, the measuring apparatus 100 can list a plurality of wafer temperature true value candidates based on the wafer temperature measurement value obtained from the peak position of the complex amplitude. In other words, the measuring apparatus 100 can extract a plurality of temperature true value candidates associated with the temperature corresponding to the temperature measurement value from the third correction table. Note that the third correction table may be a mathematical expression indicating the relationship between the wafer temperature true value and the peak position of the complex amplitude.

### (Step ST32)

In step ST32, the calculator 150 creates a fourth correction table based on the relationship between the wafer temperature true value and the measurement value of the phase angle before unwrapping. For example, as in the first embodiment, the fourth correction table is created by an experiment using the principle illustrated in FIG. 9. In the experiment, the measuring apparatus 10 measures a plurality of sets of the wafer temperature true value and the phase angle of the complex amplitude. The wafer temperature true value is based on the wafer temperature settings used in the experiments. Thereafter, the calculator 150 associates the wafer temperature true value with the phase angle to create a correlation graph between the thickness true value and the phase angle.

The correlation graph created in this manner corresponds to the fourth correction table. The fourth correction table stores candidates for the wafer temperature true value corresponding to the phase angle of the complex amplitude obtained from the measurement result of the spectrometer 140. The fourth correction table is stored in the storage device 155, for example. Since the phase angle used in the fourth correction table is the phase angle before unwrapping, the phase angle is in the range of −π to π [radian]. There may be a plurality of candidates for the wafer temperature true value. By using the fourth correction table, the measuring apparatus 100 can list a plurality of wafer temperature true value candidates based on the phase angle of the complex amplitude. Note that the fourth correction table may be a mathematical expression indicating the relationship between the wafer temperature true value and the phase angle.

### <3-2-2> Measurement Processing

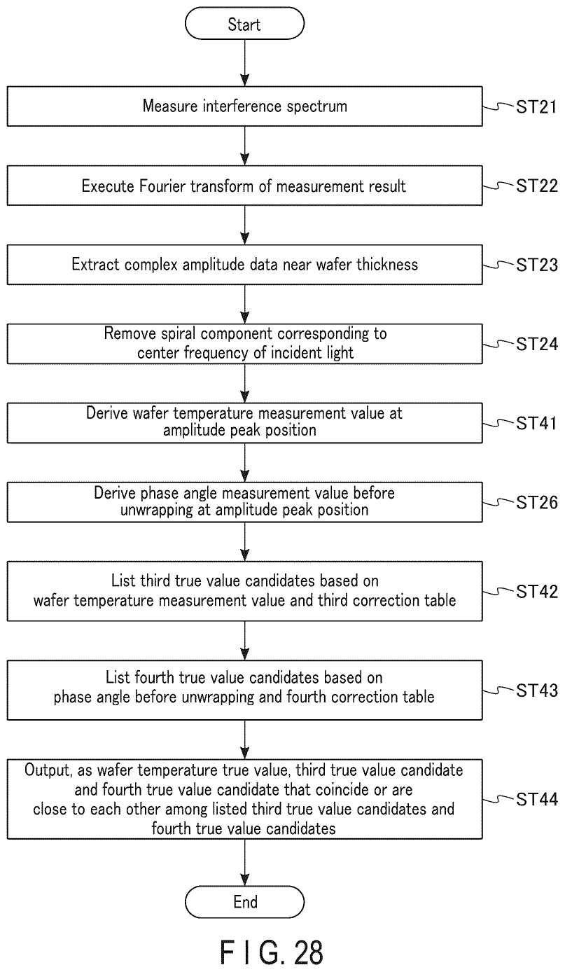

FIG. 28 is a flowchart illustrating an example of measurement processing by the measuring apparatus 100 according to the third embodiment. As illustrated in FIG. 28, in the measurement processing of the third embodiment, processing of steps ST21 to ST24, ST41, ST26, and ST42 to ST44 is sequentially executed. Note that the measurement processing can be executed during the process of the measurement target object, that is, in a state where the structure of the measurement target object changes. That is, for example, the wafer WF to be processed by the processing apparatus 200 is the measurement target object.

### (Step ST21)

In step ST21, the spectrometer 140 of the measuring apparatus 100 measures an interference spectrum as in the first embodiment.

### (Step ST22)

In step ST22, the calculator 150 of the measuring apparatus 100 executes Fourier transform of the measurement result as in the first embodiment.

### (Step ST23)

In step ST23, the calculator 150 of the measuring apparatus 100 extracts (cuts out) complex amplitude data near the wafer thickness as in the first embodiment.

### (Step ST24)

In step ST24, the calculator 150 of the measuring apparatus 100 removes a spiral component corresponding to the center frequency v₀ of the incident light as in the first embodiment.

### (Step ST41)

In step ST41, the calculator 150 of the measuring apparatus 100 derives the wafer temperature measurement value at the amplitude peak position. The calculator 150 holds the derived wafer temperature measurement value in, for example, the RAM 153.

### (Step ST26)

In step ST26, the calculator 150 of the measuring apparatus 100 derives the phase angle measurement value at the amplitude peak position similarly to the first embodiment.

### (Step ST42)

In step ST42, the calculator 150 of the measuring apparatus 100 can list third true value candidates based on the wafer temperature measurement value and the third correction table. The third true value candidate corresponds to a wafer temperature true value candidate associated with the wafer temperature measurement value derived in step ST41 in the third correction table. There may be a plurality of third true value candidates.

### (Step ST43)

In step ST43, the calculator 150 of the measuring apparatus 100 lists (extracts) fourth true value candidates based on the phase angle measurement value before unwrapping and the fourth correction table. The fourth true value candidate corresponds to a wafer temperature true value candidate associated with the phase angle corresponding to the phase angle measurement value derived in step ST26 in the fourth correction table. There may be a plurality of fourth true value candidates.

### (Step ST44)

In step ST44, the calculator 150 of the measuring apparatus 100 outputs, as the wafer temperature true value, a third true value candidate and a fourth true value candidate that coincide or are close to each other among the listed third true value candidates and fourth true value candidates as in the first embodiment. Note that, when the third true value candidate and the fourth true value candidate having the same value do not exist, the calculator 150 may output either the third true value candidate or the fourth true value candidate closest to each other as the wafer temperature true value. In addition, the calculator 150 may output a value (for example, an average value) calculated based on the closest third true value candidate and the closest fourth true value candidate as the wafer temperature true value.

Note that, in the above description, the case where the calculator 150 of the measuring apparatus 100 derives the waveform of the complex amplitude by Fourier transform of the interference spectrum has been described, but the embodiment is not limited thereto. In the measurement processing, the processing corresponding to the Fourier transform may be replaced with the inverse Fourier transform. Even in such a case, the measuring apparatus 100 can calculate the wafer temperature based on the waveform peak and the phase angle of the complex amplitude.

### <3-3> Advantageous Effects of Third Embodiment

As described above, the measuring apparatus 100 according to the third embodiment can measure the wafer temperature using the same principle as that of the first embodiment. That is, the measuring apparatus 100 according to the third embodiment can uniquely determine the wafer temperature true value by measuring one point in consideration of the initial thickness of the wafer WF. Then, the error of the wafer temperature measurement value can be corrected by deriving the thickness true value using the third correction table and the fourth correction table. Therefore, the measuring apparatus 100 according to the third embodiment can reduce an error in wafer temperature measurement using optical interference. Note that the third embodiment may be combined with the second embodiment. That is, the measurement range may be extended by extending the third correction table and the fourth correction table outside the experimental range.

### <4> Others

In the above embodiment, the flowcharts used for describing the measuring method and the method for manufacturing the semiconductor device are merely examples. The operations described with reference to the flowcharts may be interchanged in processing order within a possible range, may be executed in parallel within a possible range, other processing may be added, or some processing may be omitted. For example, the calculator 150 may execute the processing of steps ST25 and ST27 in FIG. 15 and the processing of steps ST26 and ST28 in parallel. The wafer thickness as a measurement target in the present specification is not limited to the thickness of the wafer WF, and may be the thickness of the proximity layer 300 or the total thickness of the wafer WF and the proximity layer 300. The measuring apparatus 100 according to the first embodiment can measure, for example, the thickness of the wafer WF in back grinding processing of the wafer WF. Alternatively, it is possible to measure the thickness or change in thickness of the proximity layer during etching processing or film forming processing.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A measuring apparatus comprising:
a light source configured to emit measurement light having a wavelength that transmits through a measurement target object;
a spectrometer configured to measure a spectroscopic spectrum waveform of light in which the measurement light is reflected from a measurement target object;
a storage device configured to store a first correction table and a second correction table, the first correction table including a measurement value of a thickness or a temperature and a true value of the thickness or the temperature, and the second correction table including a measurement value of a phase angle and a true value of the thickness or the temperature; and
a processor, wherein
the processor is configured to:
perform Fourier transform of the spectroscopic spectrum waveform measured by the spectrometer;
calculate a thickness or a temperature of the measurement target object as a first measurement value based on an amplitude peak position of the waveform after the Fourier transform;
calculate a phase angle before unwrapping as a second measurement value based on an amplitude peak position of the waveform after the Fourier transform;
extract a plurality of first true value candidates corresponding to the first measurement value from the first correction table;
extract a plurality of second true value candidates corresponding to the second measurement value from the second correction table; and
output, as a thickness or a temperature of the measurement target object, a value based on a first true value candidate and a second true value candidate that are same or closest among the extracted first true value candidates and the extracted second true value candidates.

2. The measuring apparatus according to claim 1, wherein
the processor is further configured to:
generate the first correction table based on a relationship between a measurement value of a thickness or a temperature calculated based on an amplitude peak position obtained in an experimental range and a true value of the thickness or the temperature; and
generate the second correction table based on a relationship between a measurement value of a phase angle before unwrapping at the amplitude peak position obtained in the experimental range and the true value of the thickness or the temperature.

3. The measuring apparatus according to claim 2, wherein
the processor is further configured to
extend each of the first correction table and the second correction table outside the experimental range based on regularity between the measurement value of the thickness or the temperature calculated from the amplitude peak position obtained in the experimental range, the measurement value of the phase angle before the unwrapping, and an error of the thickness or the temperature.

4. A measuring method using a light source configured to emit measurement light having a wavelength that transmits through a measurement target object, a spectrometer configured to measure a spectroscopic spectrum waveform of light in which the measurement light is reflected from a measurement target object, and a storage device configured to store a first correction table including a measurement value of a thickness or a temperature and a true value of the thickness or the temperature and a second correction table including a measurement value of a phase angle and a true value of the thickness or the temperature, the measuring method comprising:
performing Fourier transform of the spectroscopic spectrum waveform measured by the spectrometer;
calculating a thickness or a temperature of the measurement target object as a first measurement value based on an amplitude peak position of the waveform after the Fourier transform;
calculating a phase angle before unwrapping as a second measurement value based on an amplitude peak position of the waveform after the Fourier transform;
extracting a plurality of first true value candidates corresponding to the first measurement value from the first correction table;
extracting a plurality of second true value candidates corresponding to the second measurement value from the second correction table; and
outputting, as a thickness or a temperature of the measurement target object, a value based on a first true value candidate and a second true value candidate that are same or closest among the extracted first true value candidates and the extracted second true value candidates.

5. The measuring method according to claim 4, further comprising:
generating the first correction table based on a relationship between a measurement value of a thickness or a temperature calculated based on an amplitude peak position obtained in an experimental range and a true value of the thickness or the temperature; and
generating the second correction table based on a relationship between a measurement value of a phase angle before unwrapping at the amplitude peak position obtained in the experimental range and the true value of the thickness or the temperature.

6. The measuring method according to claim 5, further comprising
extending each of the first correction table and the second correction table outside the experimental range based on regularity between the measurement value of the thickness or the temperature calculated from the amplitude peak position obtained in the experimental range, the measurement value of the phase angle before the unwrapping, and an error of the thickness or the temperature.

7. The measuring method according to claim 4, wherein the measurement target object includes a semiconductor substrate.

8. A storage medium storing a program using a light source configured to emit measurement light having a wavelength that transmits through a measurement target object, a spectrometer configured to measure a spectroscopic spectrum waveform of light in which the measurement light is reflected from a measurement target object, and a storage device configured to store a first correction table including a measurement value of a thickness or a temperature and a true value of the thickness or the temperature and a second correction table including a measurement value of a phase angle and a true value of the thickness or the temperature, wherein
the program is configured to:
perform Fourier transform of the spectroscopic spectrum waveform measured by the spectrometer;
calculate a thickness or a temperature of the measurement target object as a first measurement value based on an amplitude peak position of the waveform after the Fourier transform;
calculate a phase angle before unwrapping as a second measurement value based on an amplitude peak position of the waveform after the Fourier transform;
extract a plurality of first true value candidates corresponding to the first measurement value from the first correction table;
extract a plurality of second true value candidates corresponding to the second measurement value from the second correction table; and
output, as a thickness or a temperature of the measurement target object, a value based on a first true value candidate and a second true value candidate that are same or closest among the extracted first true value candidates and the extracted second true value candidates.

9. The storage medium according to claim 8, wherein
the program is further configured to:
generate the first correction table based on a relationship between a measurement value of a thickness or a temperature calculated based on an amplitude peak position obtained in an experimental range and a true value of the thickness or the temperature; and
generate the second correction table based on a relationship between a measurement value of a phase angle before unwrapping at the amplitude peak position obtained in the experimental range and the true value of the thickness or the temperature.

10. The storage medium according to claim 9, wherein
the program is further configured to
extend each of the first correction table and the second correction table outside the experimental range based on regularity between the measurement value of the thickness or the temperature calculated from the amplitude peak position obtained in the experimental range, the measurement value of the phase angle before the unwrapping, and an error of the thickness or the temperature.
